(19) United States
(12) Patent Application Publication
(10) Pub. No.: US 2025/0194468 A1
(43) Pub. Date: Jun. 19, 2025

(54) METHOD, SYSTEM, AND DEVICE TO PROCESS PLANTS AND REMOVE COMPONENTS THEREFROM

(71) Applicant: S.S. STEINER, INC., New York, NY (US)

(72) Inventors: Robert Groeneveld, Grandview, WA (US); Paul Merritt, Prosser, WA (US)

(73) Assignee: S.S. STEINER, INC., New York, NY (US)

(21) Appl. No.: 19/066,338

(22) Filed: Feb. 28, 2025

Related U.S. Application Data
(63) Continuation of application No. PCT/US2023/031851, filed on Sep. 1, 2023.
(60) Provisional application No. 63/403,205, filed on Sep. 1, 2022.

(51) Int. Cl. A01D 46/02

(52) U.S. Cl. CPC A01D 46/02

(57) ABSTRACT

A device, system, and method for removing hop cones and leaves from hop vines, including a set of rotating shafts with mounted picking fingers (picking drums) which are located between sets of rotating shafts with mounted paddles (grasper drums). The grasper drums, which are rotating at a different speed than the picking drums, transport and hold the vine which the picking drums remove the cones and the leaves from the vine.

### CROSS-REFERENCE TO RELATED APPLICATIONS

This application is a continuation of International Patent Application No. PCT/US2023/031851, filed Sep. 1, 2023, which claims priority to and benefit of U.S. Provisional Application No. 63/403,205, filed Sep. 1, 2022, which are incorporated by reference herein in their entirety.

### FIELD OF THE DISCLOSED SUBJECT MATTER

The disclosed subject matter relates to a method, system, and device to process agricultural products and in particular to strip hop vines of hop cones and leaves.

### BACKGROUND

Traditional hop harvesting equipment is based on drum or bank pickers. In each case, the vine has to be held firmly by a chain or hook to avoid the vine being pulled into the picking device. Vines which are pulled out of the chain or of the hook and are pulled in their entirety into the picking device preventing it from cleanly picked and, in the worst-case, wrap around the picking drums or banks thereby forcing the operator to stop the machine and remove the vine. Even with the newer track harvesters which remove the laterals from the hop vine, these laterals are fed into stationary picking machines which are either based on drum or bank pickers. These known hop harvesting equipment often damage the cones of the vines, which can effect the quality of the cones for later processing.

To remove leaves and cones from hop vines cleanly and gently, it is required that the hop vine is fed into the machine in a straight orientation. For stationary machines, the bottom of a hop vine is put on a hook and the machine pulls in the hanging vine. Mobile harvesters grasp the bottom of the vine by firmly holding the vine with parallel running chains. As the vine must be held firmly, a certain part of the vine will not go through the picking device, which can result in some unharvested cones, reducing the yield and a loss of value. As such, there remains a continued need for an efficient and economic system to process agricultural products and in particular strip hop vines of hop cones and leaves more fully. The presently disclosed subject matter satisfies these and other needs.

### SUMMARY OF THE DISCLOSED SUBJECT MATTER

The purpose and advantages of the disclosed subject matter will be set forth in and are apparent from the description that follows, as well as will be learned by practice of the disclosed subject matter. Additional advantages of the disclosed subject matter will be realized and attained by the devices particularly pointed out in the written description and claims hereof, as well as from the appended drawings.

To achieve these and other advantages and in accordance with the purpose of the disclosed subject matter, as embodied and broadly described, the disclosed subject matter includes a device, system, and method to process agricultural products and strip hop vines of hop cones, and leaves.

In accordance with an aspect of the disclosed subject matter, a picking module to separate an article from a vine is disclosed, comprising: a housing; at least a first set of grasper drums and a second set of grasper drums disposed within the housing, wherein the first and second set of grasper drums are configured to rotate at a first speed; at least one set of picking drums disposed within the housing, wherein the at least one set of picking drums is disposed between the first set of grasper drums and the second set of grasper drums, wherein the set of picking drums are configured to rotate at a second speed faster than the first speed, wherein at least the first set of grasper drums are configured to hold the vine or at least the first and second sets of grasper drums are configured to hold the vine in tension to separate the article from the vine with the set of picking drums.

In accordance with an aspect of the disclosed subject matter, a system of separating an article from a vine is disclosed, comprising: a feeding system to convey a vine having an article thereon; a picking module to receive the vine from the feeding system, the module comprising a housing, at least a first set of grasper drums and a second set of grasper drums disposed within the housing, wherein the first and second set of grasper drums rotate at a first speed, and at least one set of picking drums disposed within the housing, wherein the at least one set of picking drums is disposed between the first set of grasper drums and the second set of grasper drums and the set of picking drums rotate at a second speed faster than the first speed, wherein the first and second sets of grasper drums and the set of picking drums are configured to at least one of hold the vine in tension and separate the article from the vine; and a collection device configured to receive the article from the vine.

In accordance with an aspect of the disclosed subject matter, a method of separating an article from a vine is disclosed, comprising: feeding a vine having an article thereon into a picking module at a predetermined angle, wherein the picking module comprises a housing, at least a first set of grasper drums and a second set of grasper drums disposed within the housing, at least one set of picking drums disposed within the housing, wherein the at least one set of picking drums is disposed between the first set of grasper drums and the second set of grasper drums; rotating the first and second set of grasper drums at a first speed and rotating the set of picking drums at a second speed faster than the first speed; holding the vine in tension between the first set of grasper drums and the second set of grasper drums; and separating the article from the vine with at least the set of picking drums.

As further described herein and as shown in the accompanying FIGS. 1-8, the disclosed subject matter includes grouping sets consistent of a set of rotating shafts with mounted picking fingers (picking drum) in between sets of rotating shafts with mounted paddles/sheets (grasping drum). As the picking drums rotate at a different speed than the grasper drums, the vine is held at a tension, allowing the picking fingers to remove the cones and leaves. In this set up, the vine is moved through the picking device in its entirety and does not require that the vine is firmly held by a grasper chain or hook. This allows the vine to be picked completely and cleanly. Furthermore, it was discovered that the vine can be fed into the machine bottom or top first and even partially folded in the middle, which simplifies the process particularly if vines shall be fed automatically into the picking device. It was also discovered that the grouping of sets of picking drums and grasping drums avoids that the vine and its sidearms are squeezed together. This avoids that the side arms are ripped off the vine or that cones are either damaged or left on the vine.

According to embodiments of the disclosed subject matter, the set of rotating shafts with mounted picking fingers (picking drums) can be located between sets of rotating shafts with mounted paddles (grasper drums), as provided in the figures. The grasper drums, which can rotate at a different speed than the picking drums, transport and hold the vine which the picking drums remove the cones and the leaves from the vine.

It is to be understood that both the foregoing general description and the following detailed description and drawings are examples and are provided for purpose of illustration and not intended to limit the scope of the disclosed subject matter in any manner.

The accompanying drawings, which are incorporated in and constitute part of this specification, are included to illustrate and provide a further understanding of the devices of the disclosed subject matter. Together with the description, the drawings serve to explain the principles of the disclosed subject matter.

### BRIEF DESCRIPTION OF THE DRAWINGS

The subject matter of the application will be more readily understood from the following detailed description when read in conjunction with the accompanying drawings, in which:

FIG. 1A is a side-view of a picking module device having series of rotating shafts with mounted paddles followed by rotating shafts with mounted picking fingers, according to embodiments of the disclosed subject matter.

FIG. 1B is an exploded view of components of the picking module device of FIG. 1A, according to embodiments of the disclosed subject matter.

FIG. 2 is top view of the device of FIG. 1A, according to embodiments of the disclosed subject matter.

FIG. 3A is a detailed top view of a single grasping drum with mounted paddles and FIG. 3B is a side view of the grasping drum, according to embodiments of the disclosed subject matter.

FIG. 4A is a detailed top view of a single picking drum with mounted fingers and FIG. 4B is a side view of the picking drum, according to embodiments of the disclosed subject matter.

FIG. 4C is a side view of the picking drum, according to embodiments of the disclosed subject matter.

FIG. 5 is flow chart of the system and method of the disclosed subject matter according to embodiments of the disclosed subject matter.

FIG. 6 is a side-view of the picking module device having a series of rotating shafts with mounted paddles followed by rotating shafts with mounted picking fingers as multiple vines pass through the module, according to embodiments of the disclosed subject matter.

FIG. 7 is a top-view of the device of FIG. 6.

FIG. 8 is a side view of a mobile harvester including a picking module device, according to embodiments of the disclosed subject matter.

### DETAILED DESCRIPTION

Reference will now be made in detail to embodiments of the disclosed subject matter, an example of which is illustrated in the accompanying drawings. The disclosed subject matter will be described in conjunction with the detailed description of the system.

The present disclosure generally describes a device, system and method for effectively processing agricultural products and in particular to strip of cones and flowers. Such enhancements include striping a greater percentage of the cones and flowers without crushing the cones and flowers, and allowing the vine to be fed into the system in any configuration or orientation.

In accordance with an aspect of the disclosed subject matter, a picking module to separate an article from a vine is disclosed, comprising: a housing; at least a first set of grasper drums and a second set of grasper drums disposed within the housing, wherein the first and second set of grasper drums are configured to rotate at a first speed; at least one set of picking drums disposed within the housing, wherein the at least one set of picking drums is disposed between the first set of grasper drums and the second set of grasper drums, wherein the set of picking drums are configured to rotate at a second speed faster than the first speed, wherein at least the first set of grasper drums are configured to hold the vine or at least the first and second sets of grasper drums are configured to hold the vine in tension to separate the article from the vine with the set of picking drums.

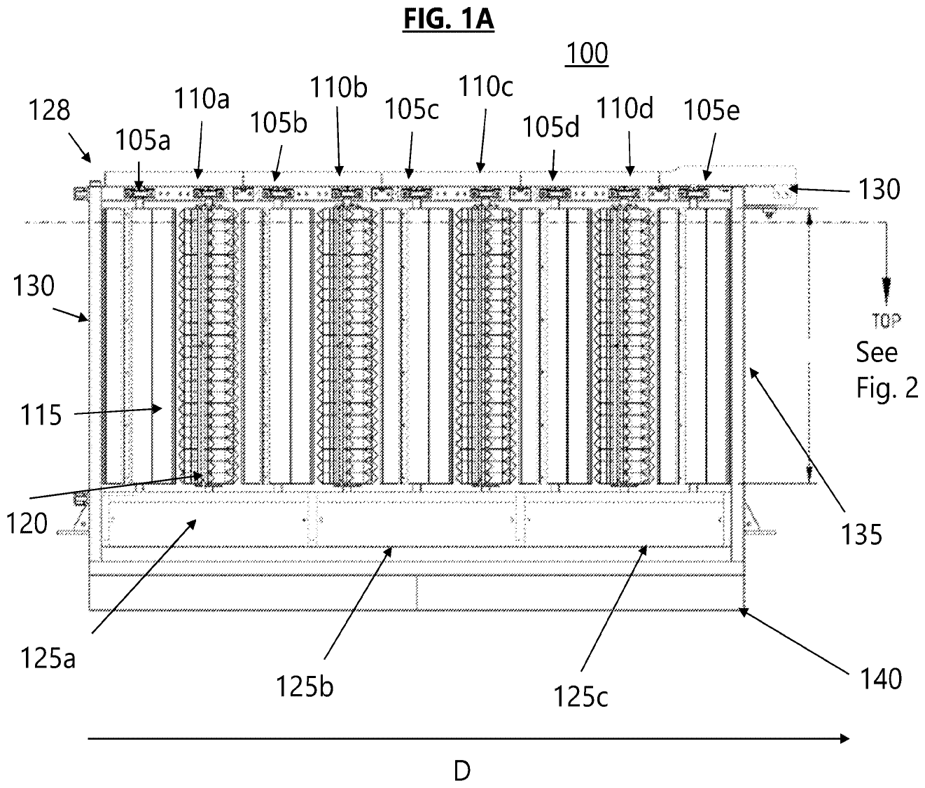

In particular, FIG. 1A shows a diagram of an illustrative picking module 100 that incorporates the grasping system and picking system of the present disclosure and FIG. 1B shows an exploded view of components of the picking module device of FIG. 1A. As shown, the picking module 100 can include a housing 128 having a front 130, a back 135, a bottom 140, and a top 145. The housing can house and support the sets of picking drums and grasper drums as further described herein. The housing can comprise any suitable material to support the picking and grasping drums thereon, such as but not limited to steel.

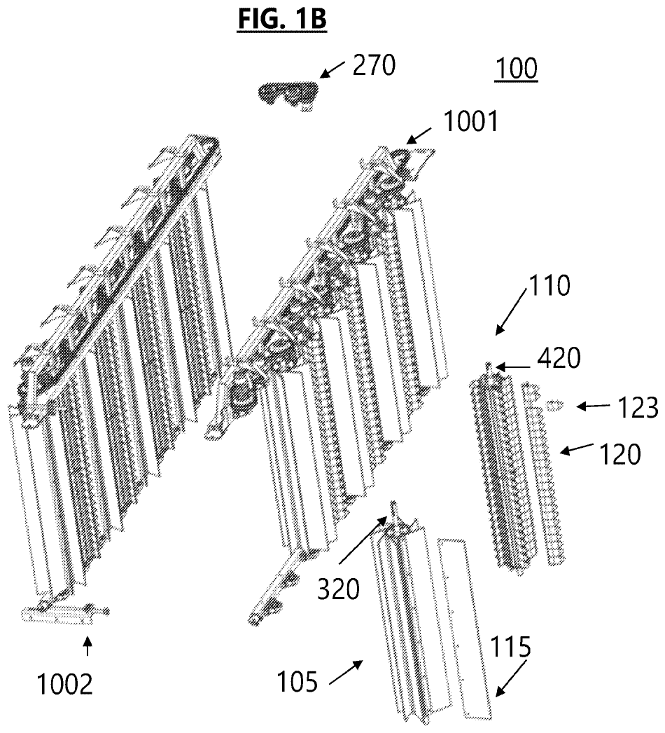

The picking module 100 can include at least a first set of grasper drums 105a and a second set of grasper drums 105b disposed within the housing 128. Each set of grasper drums includes a first drum and a second drum that operate as a gear system, as best shown in FIG. 2 and described below. As such, the first drum rotates in an opposite direction as the second drum and either drum can be the driving drum or the driven drum. The drums are disposed on respective sets of rotating shafts that can be coupled to a drive system 270 as best shown in FIG. 1A. The drive system can include a single motor to drive all sets of drums within a housing or alternatively can include a plurality of motors to drive select sets of drums. The housing can include a plurality of additional grasping drums 105c, 105d, and 105e also disposed within the housing, as shown in FIG. 1A. All the plurality of sets of grasping drums are configured to rotate at a first speed. Each grasping drum 105 includes a plurality of paddles 115 configured to contact and hold the vine in tension as the vine is moved through the picking module 100 along direction “D” by the grasping drums 105.

The picking module 100 can also include at least one set of picking drums 110a, 110b, 110c, 110d disposed within the housing 128. Each set of picking drums includes a first picking drum and a second picking drum that operate as a gear system, as best shown in FIG. 2 and described below. As such, the first picking drum rotates in an opposite direction as the second picking drum and either picking drum can be the driving drum or the driven drum. The picking drums are disposed on respective sets of rotating shafts that can be coupled to the same drive system as the grasper drums or a separate drive system. The picking drums are disposed after a set of grasping drums 105. Each of the at least one set of picking drums are configured to rotate a speed greater than the first speed of the grasper drums. Each picking drum 110 includes a plurality of picking fingers 120 that are configured to strip the vine as the vine passes through the picking module 100 along direction “D”.

The module 100 further includes a plurality of containers 125a, 125b, and 125c disposed within the housing below the picking drums 110, as shown in FIG. 1A. The containers are configured to hold the portions of the vines that are stripped by the picking drums 110, such as cones and flowers. The containers can be replaced when they are filled with the stripped product from the vines being processed.

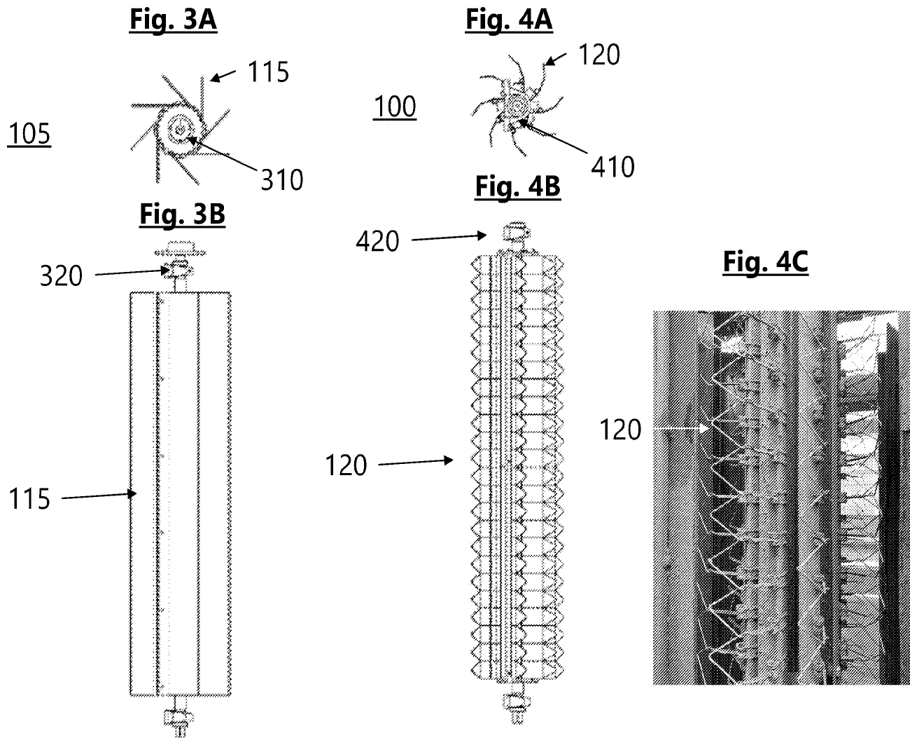

Each of the grasping drum sets 105 and the picking drum sets 110 can be connected to the housing by independent frames that can be coupled to the housing 128, such as by bolts. As such, the individual sets of drums coupled with the respective frames can be disconnected from the housing for quick and easy replacement or for general maintenance. As shown in FIG. 1B, the individual grasping drums 105 and picking drums 110 can be connected to a respective frame 1002 by the respective rotative shafts 320 and 420 of the drums. In this embodiment, the picking module 100 includes a driving system 270 that is configured to control rotation of the rotating shafts through a belt 1001 that couples all the grasping drums 105 for rotation together. As described herein, the picking drum 110 can include fingers 120 coupled to the picking drum. As shown in FIG. 1B, a single finger 123 of the plurality of fingers 120 can be seen in the exploded view and includes the same shape as described above with reference to FIG. 4C described herein.

Although the housing of FIG. 1A has oriented the drums as vertically situated such that the sets of drums are perpendicular to the ground, the housing can be alternatively disposed horizontally such that the sets of drums are parallel to the ground.

FIG. 2 shows a top view of the picking module 100 that shows a vine 101 being processed by the picking module 100. The picking module 100 includes a plurality of sets 255 of grasping drums 105. As noted above, each set of grasping drums includes a first grasping drum 255a and a second grasping drum 255b disposed adjacent to the first set of grasping drums 255a. The first grasping drum 255a and the second grasping drum 255b are disposed on a set of adjacent rotating shafts that are configured to rotate at a first speed. Each grasping drum 105 in each set 255 is configured to rotate in a select direction such as either a first direction or a second direction. The first direction can be clock-wise and the second direction can be counter-clockwise or vice versa. In use, one grasping drum in each set of grasping drums is configured to rotate in the first direction and the second grasping drum is configured to rotate in the second direction opposite to the first direction.

Grasping drums 105 can each comprise a plurality of spaced apart paddles 115 that are coupled to the drums 105 and extend radially outwards. The paddles 115 rotate along with the grasping drums 105 along a path 230. The path 230 of the paddles 115 of each grasping drum 105 in each set of grasping drums 255 overlap in the space 240 between the two respective drums to interlace the paddles in a respective set of grasping drums. By interlacing the paddles 115 during rotation, the vine 101 can be grasped and advanced through the picking module 100 in direction “D” in a controlled manner as shown in FIG. 2.

As described above, the picking module 100 can include a plurality of sets 260 of picking drums 110. Each set of picking drums includes a first picking drum 260a and a second picking drum 260b disposed adjacent to the first set of picking drums 260a. The first picking drum 260a and the second picking drum 260b are disposed on a set of adjacent rotating shafts. Each picking drum is configured to rotate in a select direction such as either a first direction or a second direction. The first direction can be clock-wise and the second direction can be counter-clockwise or vice versa. In use, a first picking drum in a set can rotate in the same direction as the second picking drum or in the opposite direction as the second picking drum. In a set of picking drums, one picking drum runs clockwise and the other one counter-clockwise. In some embodiments, the direction of a picking drum is the same as an adjacent grasping drums. Picking drums 110 can comprise a plurality of fingers 120 that are coupled to the drum 110 and extend radially outwards. The fingers 120 rotate along with the drums 110 along a circular path 225. The fingers 120 are configured to strip an article off of the vine as the passes the set of picking drums.

While five sets 255 of grasping drums 100 are shown in FIGS. 1A and 2, embodiments of the present disclosure are not limited to such quantity. A picking module as described herein can include two, three, four, five, six, seven, eight, nine, or ten sets of grasping drums. Likewise, while FIG. 2 shows four sets 260 of picking drums 105, embodiments of the present disclosure are not limited to such quantity. A picking module as described herein can include two, three, four, five, six, seven, cight, or nine sets of picking drums.

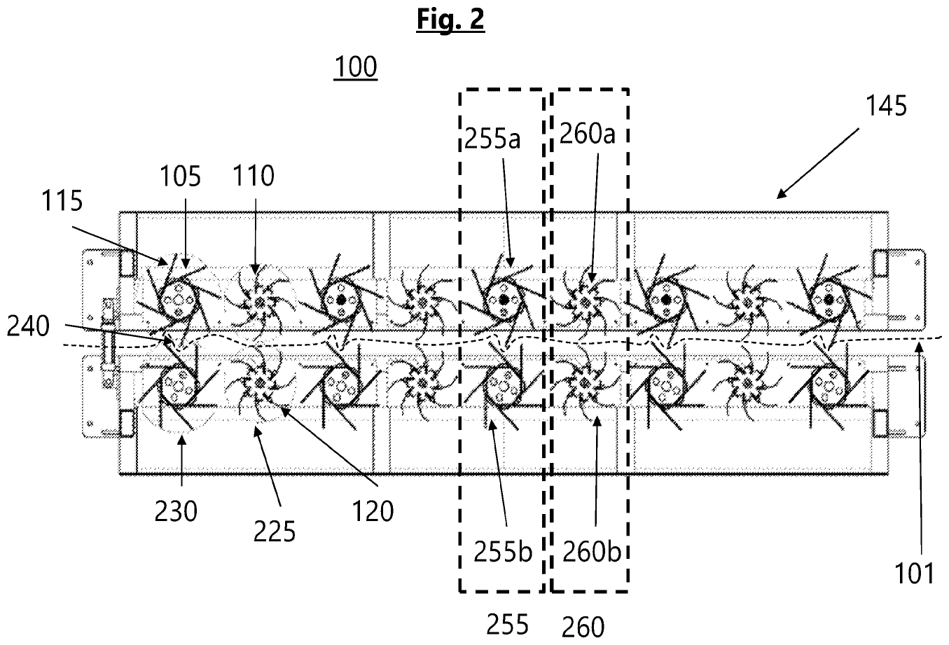

FIG. 3A depicts a single grasping drum 105 according to embodiments of the disclosed subject matter. The grasping drum 105 includes an inner portion 310 and a plurality of paddles 115 mounted to the inner portion 310. The inner portion 310 can be mounted on a rotating shaft to control rotation of the plurality of paddles 115, as further described above. In some embodiments, a single grasping 105 drum can comprise eight paddles 115 coupled to in the inner portion 310. In other embodiments, each grasping drum 105 can comprise one, two, three, four, five, six, seven, eight, nine, ten, cleven, or twelve paddles. It is contemplated that the number of paddles can vary based on the selectable diameter of the drum and that any number of paddles can be utilized with embodiments of the disclosed subject matter. The number of paddles that are mounted to each grasping drum can vary based on the type of article that will be stripped and the speed that the drum rotates.

FIG. 3B shows the grasping drum 105 mounted on a shaft 320. The grasping drum 105 can be connected to a suitable drive system for controlling rotation of the shaft. The front set of grasping drums can be individually driven by a drive motor. Other suitable methods of controlling the rotation of a shaft are well-known in the art. Additional sets of grasping drums can be connected to the first set through chains, belts, or other suitable methods known in the art. This type of connection can ensure that all of the grasping drums rotate at the same speed. By rotating all the grasping drums at the same speed, the vine is pulled through the device smoothly and without risk of tearing by applying a constant tension to the vine with the grasping drums. The drums can rotate at speeds in the inclusive range of 10 repetitions per minute (rpm) to 60 rpm.

Each paddle 115 can be made of a suitable material, such as but not limited to wood, pressed fibers, metal like aluminum, or a polymer like high density polyethylene. Further, each paddle 115 can comprise at least a straight edge and have a generally rectangular shape although other suitable shapes are contemplated herein. The surface of the paddle can be smooth or be a corrugated, rigged surface to provide additional contact points with the vine.

FIG. 4A depicts a picking drum according to embodiments of the present disclosure. Picking drum 110 includes an inner portion 410 and a plurality of fingers 120 coupled to the inner portion 410 and configured to remove the articles from the vine. The inner portion 410 can be mounted on a rotating shaft 420 to control rotation of the plurality of fingers 120. In some embodiments, a single picking drum can comprise eight fingers 120 coupled to in the inner portion 410. In other embodiments, each picking drum 110 can comprise two, three, four, five, six, seven, eight, nine, ten, eleven, or twelve fingers. The fingers 120 can comprise a curved shape configured to remove the article from the vine. Each finger 120 can be made of a suitable material such as but not limited to a metal or polymer, as is known in the art.

FIG. 4B shows an individual picking drum 110 mounted on a shaft. The picking drum 110 can be connected to a suitable driving means for controlling rotation of the shaft. In embodiments with a plurality of sets of picking drums, any combination of sets of picking drums can be driven by the same motor or by different motors. The picking drums can be each individually driven by different types of motors such as a drive motor. Other suitable methods of controlling the rotation of a shaft are well-known in the art. Sets of picking drums driven by the same driving means can be connected through chains, or other suitable methods known in the art, such that all the picking drums rotate at the same speed. Additionally, the picking drums can rotate at speeds in the inclusive range of 20 repetitions per minute (rpm) to 500 rpm.

As seen in FIG. 4C, the picking fingers 120 of a picking drum can comprise frames, such as a plurality triangular segments that are connected to the inner portion of the picking drum at the base. Each finger can at least include an apex potion and two sides that extend away from the apex at an angle. Each finger can additionally include two linear portions that extends from the sides and couple to the drum.

In some embodiments, the speed of different sets of picking drums in the picking module can be different or the same. In some cases, the speed of each picking drums can increase along the direction “D” such that later picking drums rotate faster than the drums closer to the front end of the picking module. Picking drums that are rotating quickly can strip the vine more fully than slower rotating drums, but the increased speed of the drum can tear the vine if it is full of flowers and cones. By beginning to strip the vines with slower rotating picking drums, a first subset of articles can be removed without risk of tearing the vine and destroying the cones. After the vine has been thinned of a first volume of the articles, faster spinning drums can strip the vine more fully without the risk of tearing the vine.

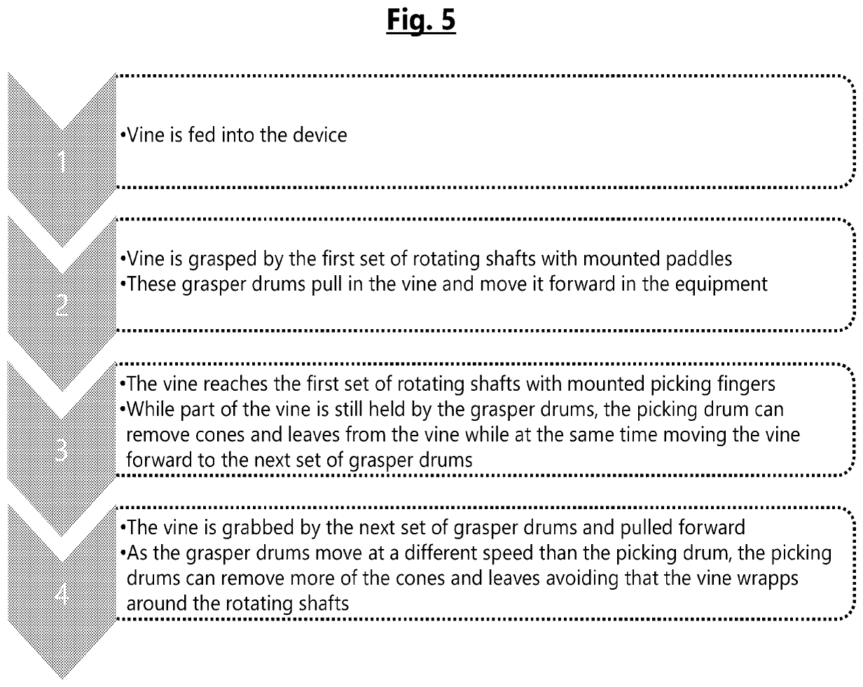

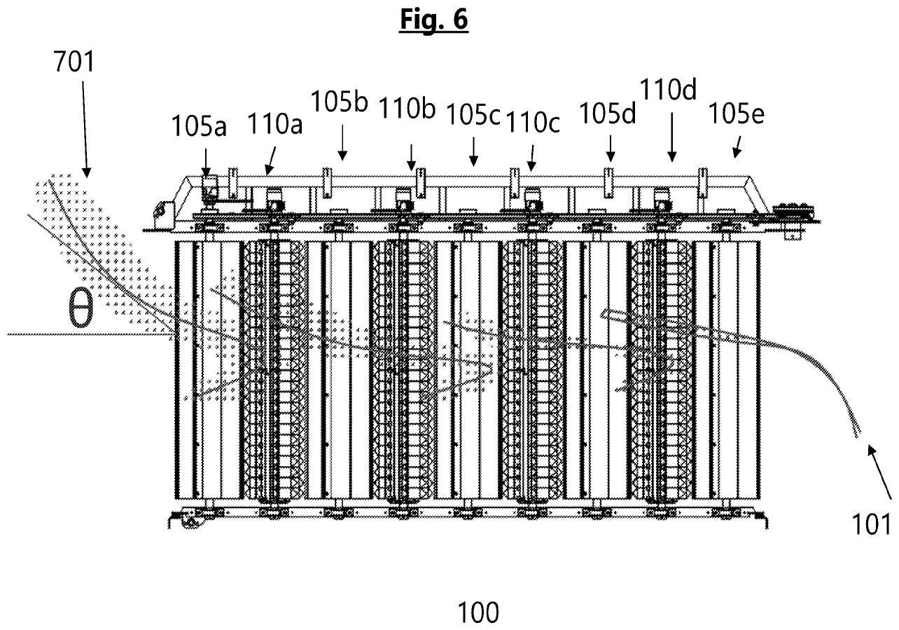

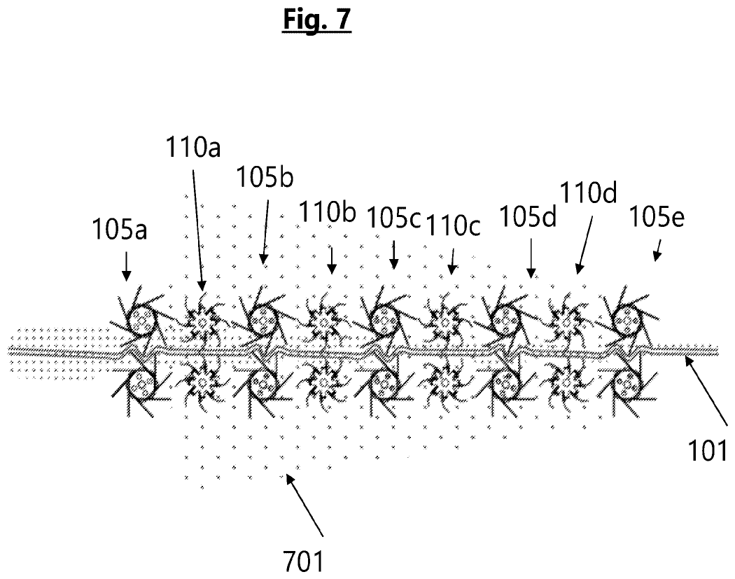

FIG. 5 provides a flow chart of the process and method contemplated by the disclosed subject matter and FIGS. 6 and 7 show select steps of the process and method.

At step 1, a vine is fed into the picking module. The vine can be fed into the device in any configuration and still achieve the benefits of the improved picking efficiencies of the described invention. The vine can be fed substantially parallel to the direction “D” of the picking module or at any angle relative to the direction “D”. For example, the vine can be fed at a predetermined angle between a length of the vine and the direction “D”, such as any angle between 0 degrees and 90 degrees. Vines can be fed in a substantially straight configuration or in a folded configuration.

As shown in FIG. 6, vines 101 with attached articles thereon 701 pass through the picking module. As can be seen in FIG. 6, as a vine passes through the picking module 100, the number of articles 701 that are connected to each vine 101 is reduced at each picking module 110 as the vine advances down the system in the direction “D”. Additionally, the vines 101 are shown passes through the picking module 100 in a plurality of different configurations as has been described above. The picking module 100 as described herein does not require that the vines 101 be in a substantially straight configuration when they enter the picking module 100. Rather, the vines 101 can be straight or folded and enter the picking module 100 at an any angle θ relative to the direction they travel through the picking module while still experiencing the benefits of the picking module. FIG. 7 shows a plan view of the vines 101 moving along the direction “D” with the articles 701 being separated from the vines 101 by the processing system.

At step 2, the vine is grasped by a first set of grasping drums disposed on adjacent rotating shafts rotating at a first speed. As the shafts rotate, the paddles disposed on the grasping drums on each drum in the respective set overlap and are interlaced to hold the vine, as shown in FIGS. 6 and 7. The rotation of the first set of grasping drums pulls the vine in and moves the vine forward through the picking module.

At step 3, the vine reaches the first set of picking drums which are disposed on an adjacent set of rotating shafts rotating at a second speed. While part of the vine is still held by the first set of grasper drums, the picking drums can remove cones and leaves from the vine while at the same time helping to move the vine forward to the next set of grasper drums, as shown in FIGS. 6 and 7. The second speed can be in the range of 20 rpm to 500 rpm, preferably 300 rpm.

At step 4, the vine is grabbed by a second set of graspers drums and is pulled forward, as shown in FIGS. 6 and 7. At this step, the first set of grasping drums and the second set of grasping drums hold the vine in tension between the two sets of grasping drums. The second set of grasping drums are likewise disposed on a set of adjacent shafts rotating at the first speed. As the shafts rotate, the paddles disposed on the grasping drums on each drum in the respective set overlap and are interlaced to hold the vine in tension with the first set of grasping drums. The first speed can be in the range of 1 rpm to 1000 rpm, for hops the preferable range is from 10 to 100 rpm, and is 5% to 50% slower than the second speed.

While the method described above only includes two sets of grasping drums and one set of picking drums, embodiments of the present disclosure are not limited to such a quantity. Additional sets of grasping and picking drums can be disposed downstream of the second set of grasping drums such as is shown in FIGS. 1A and 2. In such embodiments, the method would continue by repeating steps 2-4 with the second set of grasping drums moving the vine towards a second set of picking drums rotating at the second speed or a third speed greater than the first speed and disposed between the second set of grasping drums and a third set of grasping drums rotating at the first speed. The third speed can be identical to the second speed or different speed as long as it is faster than the first speed. The third set of grasping drums would hold the vine tension with the second set of grasping drums. Steps 2-4 can be repeated with additional sets of grasping and picking drums as described herein until the vine is grasped by and moved out of the picking module by a terminal set of grasping drums. Throughout the process, as articles such as cones, flowers, fruits, or leaves are striped from the vine by the picking module, the articles can be captured in bins, containers, or other boxes for storing and additional processing. In some embodiments, the most picking drums furthest from the front end of the picking module are configured to break the vine into a plurality of pieces such that they can be recycled.

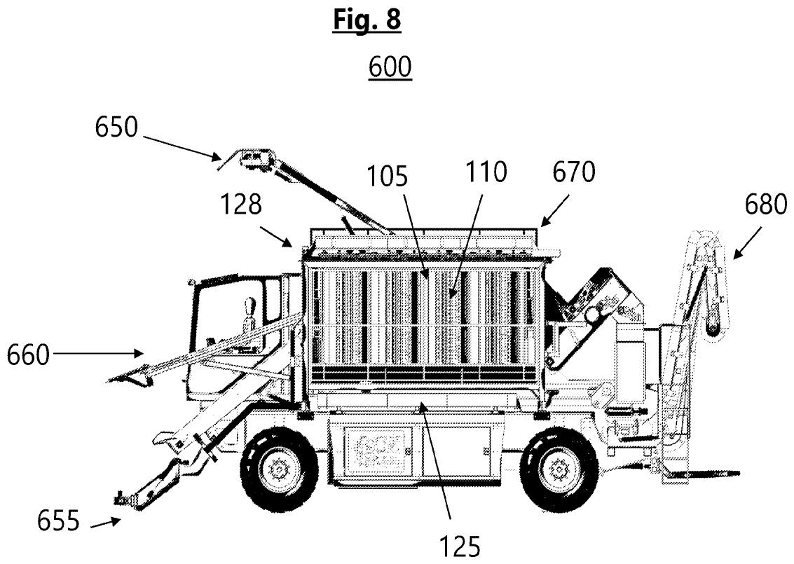

FIG. 8 shows an exemplary mobile harvester 600 including the picking module 100 disclosed herein, according to the embodiments described herein. Mobile harvester 600 includes top cutter 650 and bottom cutter 655, as are well-known in the art. The top cutter 650 is connected to the mobile harvester 600 and is configured to cut the vine from a top support, such as a trellis. Likewise, the bottom cutter 655 is connected to the mobile harvester 600 and is configured to cut the vine from a bottom support, such as a trellis or from the root of the vine itself. The mobile harvester includes a conveyor assembly 660 that can be used to feed the vine into the picking module 670. The picking module 670 can be substantially similar to the picking module 100 described above including housing 127, grasping drums 105, picking drums 110, containers 125, that are used to move a vine through the picking module to capture the cones and flowers that are stripped from the vine as it passes through the picking module 670. The mobile harvester can further comprise an exit conveyor 680.

While the disclosed subject matter is described herein in terms of certain preferred embodiments, those skilled in the art will recognize that various modifications and improvements can be made to the disclosed subject matter without departing from the scope thereof. Moreover, although individual features of one embodiment of the disclosed subject matter can be discussed herein or shown in the drawings of the one embodiment and not in other embodiments, it should be apparent that individual features of one embodiment can be combined with one or more features of another embodiment or features from a plurality of embodiments.

In addition to the various embodiments depicted and claimed, the disclosed subject matter is also directed to other embodiments having any other possible combination of the features disclosed and claimed herein. As such, the particular features presented herein can be combined with each other in other manners within the scope of the disclosed subject matter such that the disclosed subject matter includes any suitable combination of the features disclosed herein. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the device, system, and method of the disclosed subject matter without departing from the spirit or scope of the disclosed subject matter. Thus, it is intended that the disclosed subject matter include modifications and variations that are within the scope of the appended claims and their equivalents.

What is claimed is:

1. A picking module to separate an article from a vine, comprising:
a housing;
at least a first set of grasper drums and a second set of grasper drums disposed within the housing, wherein the first and second set of grasper drums are configured to rotate at a first speed;
at least one set of picking drums disposed within the housing, wherein the at least one set of picking drums is disposed between the first set of grasper drums and the second set of grasper drums, wherein the set of picking drums are configured to rotate at a second speed faster than the first speed,
wherein at least the first set of grasper drums is configured to hold the vine or at least the first and second sets of grasper drums are configured to hold the vine in tension to separate the article from the vine with the set of picking drums.

2. The system of claim 1, wherein each drum of the first set of grasping drums, the second set of grasping drums, and the picking drum is disposed on a respective rotating shaft.

3. The module of claim 1, wherein each drum of the first set of grasping drums comprises a plurality of spaced apart paddles coupled thereto, and wherein each drum of the second set of grasping drums comprises a plurality of spaced apart paddles coupled thereto.

4. The module of claim 3, wherein the paddles of one set of the first set of grasper drums are configured to be interlaced with the paddles of the other set of the first set of grasper drums during rotation thereof, wherein the paddles of the first set and second set of grasper drums are configured to grasp and advance the vine in a first direction.

5. The module of claim 3, wherein the first set and second set of grasper drums each have eight paddles coupled thereto.

6. The module of claim 3, wherein the paddles comprise at least one of metal, a synthetic material, wood, pressed fibers, and high density polyethylene.

7. The module of claim 3, wherein the paddles comprise at least one of a straight edge and a corrugated, rigged surface.

8. The module of claim 1, wherein each drum of the set of picking drums comprise a plurality of spaced apart fingers coupled thereto and configured to remove the articles from the vine.

9. The module of claim 8, wherein the plurality of spaced apart fingers includes a curved surface configured to remove the articles from the vine.

10. The module of claim 1, wherein the first speed is between 5% and 50% slower than the second speed.

11. The module of claim 1, wherein one grasper drum of the first set of grasper drums is configured to rotate in a clockwise direction and the other grasper drum of the first set of grasper drums is configured to rotate in a counter-clock direction.

12. The module of claim 2, further comprising: a second set of picking drums disposed within the housing and adjacent the second set of grasper drums, wherein the second set of picking drums are configured to rotate at the second speed and to remove an article from the vine.

13. The module of claim 12, further comprising a third set of grasper drums disposed within the housing and adjacent the second set of picking drums, the third set of grasper drums rotating at the first speed.

14. The module of claim 3, wherein the paddles are configured to grasp the vine and advance the vine in a first direction, and wherein the at least one set of picking drums is configured to separate the article from the vine.

15. The module of claim 8, wherein the article comprises at least one of: a hop, a cone, a flower, a fruit, or a leaf.

16. A system of separating an article from a vine, comprising:
a feeding system to convey a vine having an article thereon;
a picking module to receive the vine from the feeding system, the module comprising
a housing,
at least a first set of grasper drums and a second set of grasper drums disposed within the housing, wherein the first and second set of grasper drums rotate at a first speed, and
at least one set of picking drums disposed within the housing, wherein the at least one set of picking drums is disposed between the first set of grasper drums and the second set of grasper drums and the set of picking drums rotate at a second speed faster than the first speed,
wherein the first and second sets of grasper drums and the set of picking drums are configured to at least one of hold the vine in tension and separate the article from the vine; and
a collection device configured to receive the article from the vine.

17. A method of separating an article from a vine, comprising:
feeding a vine having an article thereon into a picking module at a predetermined angle,
wherein the picking module comprises
a housing,
at least a first set of grasper drums and a second set of grasper drums disposed within the housing,
at least one set of picking drums disposed within the housing, wherein the at least one set of picking drums is disposed between the first set of grasper drums and the second set of grasper drums;
rotating the first and second set of grasper drums at a first speed and rotating the set of picking drums at a second speed faster than the first speed;
holding the vine in tension between the first set of grasper drums and the second set of grasper drums; and
separating the article from the vine with at least the set of picking drums.

18. The method of claim 17, wherein each drum of the first set of grasping drums comprise a plurality of spaced apart paddles coupled thereto and wherein each drum of the second set of grasping drums comprise a plurality of spaced apart paddles coupled thereto,
the method further comprising: grasping the vine with a first set of paddles mounted on the first set of grasping drums; and grasping the article with a set second of paddles coupled to the second set of grasping drums to hold the vine in tension between the first set of grasper drums and the second set of grasper drums.

19. The method of claim 17, wherein the first speed is between 5% and 50% slower than the second speed.

20. The method of claim 17, wherein the article is a vine, and wherein the portion is at least one of: a hop, a cone, or leaf.
